(19) United States
(12) Patent Application Publication
(10) Pub. No.: US 2022/0281022 A1
(43) Pub. Date: Sep. 8, 2022

(54) Method for Igniting a Welding Arc

(71) Applicant: Fronius International GmbH, Pettenbach (AT)

(72) Inventor: Dominik Söllinger, Pettenbach (AT)

(21) Appl. No.: 17/632,536

(22) PCT Filed: Jul. 14, 2020
(86) PCT No.: PCT/EP2020/069919

§ 371 Date: Feb. 3, 2022

(30) Foreign Application Priority Data
Aug. 6, 2019 (EP) 19190196.6

(51) Int. Cl. B23K 9/067

(52) U.S. Cl. CPC B23K 9/067

(57) ABSTRACT

Method and device for igniting and/or re-igniting a welding arc (SLB) between a wire end of a consumable welding wire electrode (SDE) and a workpiece (W), comprising the steps of: determining (S1) a distance (S) or time duration required by the wire end of the consumable welding wire electrode, SDE, until contact or short-circuit with a surface of the workpiece (W); and igniting (S2) the welding arc (SLB) with an ignition energy, E_{Z}, which is set in dependence upon the determined distance (S) or time duration.

### PRIORITY CLAIM

This application is a 35 U.S.C. § 371 National Stage Application of PCT/EP2020/069919, filed on Jul. 14, 2020, which claims the benefit of priority to Serial No. EP 19190196.6, filed on Aug. 6, 2019 in Europe, the disclosures of which are incorporated herein by reference in their entirety

### TECHNICAL FIELD

The invention relates to a method and a device for igniting and/or re-igniting a welding arc between a wire end of a consumable welding wire electrode and a workpiece.

### TECHNICAL BACKGROUND

In arc welding, a welding arc burns between a workpiece and a welding wire electrode, which melts in the process and thus simultaneously serves as a filler material. The welding arc burns between the workpiece and the welding wire electrode, reaching temperatures of more than 4000 K. Since the welding arc acts on a very small surface of the workpiece, the power density in arc welding is relatively high, thus facilitating a high welding speed. The welding arc is ignited by means of so-called contact ignition, wherein the welding wire electrode contacts the workpiece. By reason of the short-circuit, a high electrical current flows which causes the welding wire electrode to melt at its tip or at its welding wire end and ignites the welding arc.

However, during the ignition procedure the welding wire end of the welding wire electrode can remain welded to the surface of the tool when it comes into contact therewith, thus preventing ignition of the welding arc. Furthermore, the welding arc between the welding wire end and the surface of the workpiece can break off during the welding process, thus making re-ignition of the welding arc necessary. In the case of conventional welding arc methods, the thermal state of the wire end of the welding wire electrode is not taken into account. Consequently, in the case of conventional welding arc methods, the free welding wire end of the welding wire electrode is not supplied with a suitable ignition energy, and so arc breaks or welding start faults can occur during re-ignition. Accordingly, there is a need to provide a method and a device for igniting or re-igniting a welding arc between a wire end of a consumable welding wire electrode and a workpiece, which prevents welding start faults and reliably ignites or re-ignites the welding arc during the welding procedure.

### SUMMARY OF THE INVENTION

The invention provides according to an aspect a method for igniting and/or re-igniting a welding arc between a wire end of a consumable welding wire electrode and a workpiece comprising the steps of:

determining a distance or time duration required by the free wire end of the consumable welding wire electrode until contact or short-circuit with a surface of the workpiece, and

igniting the welding arc with an ignition energy which is set in dependence upon the determined distance or determined time duration.

In a possible embodiment of the method in accordance with the invention, the free wire end of the consumable welding wire electrode is formed by severing the welding wire electrode at a melting point.

In a further possible embodiment of the method in accordance with the invention, the severing of the welding wire electrode is effected by applying a high electrical current to the welding wire electrode and/or by reducing or even rendering negative the wire feed speed.

In a further possible embodiment of the method in accordance with the invention, the severing of the welding wire electrode is effected by applying current and/or by reducing the wire feed speed as soon as a short-circuit between the welding wire electrode and the workpiece has been detected.

In a further possible embodiment of the method in accordance with the invention, the consumable welding wire electrode is conveyed towards the surface of the workpiece at a wire conveying speed while the welding arc is burning.

In a further possible embodiment of the method in accordance with the invention, extinction of the welding arc is identified during conveyance of the welding wire electrode.

In a further possible embodiment of the method in accordance with the invention, the distance covered by the wire end of the consumable welding wire electrode formed at the melting point until contact or short-circuit with the surface of the workpiece is determined in dependence upon the wire conveyance speed and/or a detected time difference.

In a further possible embodiment of the method in accordance with the invention, the distance covered by the wire end of the consumable welding wire electrode formed at the melting point until contact or short-circuit with the surface of the workpiece is determined in dependence upon a wire conveyance acceleration and a detected time difference.

In a further possible embodiment of the method in accordance with the invention, the detected time difference includes a time period between the time of severance of the consumable welding wire electrode and/or extinction of the welding arc and the time of contact or short-circuit of the wire end of the consumable welding wire electrode with the surface of the workpiece.

In a further possible embodiment of the method in accordance with the invention, the distance or time duration required by the wire end of the consumable welding wire electrode until contact or short-circuit with the surface of the workpiece is measured by sensors.

In a further possible embodiment of the method in accordance with the invention, the ignition energy for igniting and/or re-igniting the welding arc is automatically set higher than a normal ignition energy when an increasing distance is determined or when an increasing time duration is determined.

In a further possible embodiment of the method in accordance with the invention, associated parameter sets for welding parameters are read out from a parameter set memory for various distance values of the distance or detected time difference values, and the ignition energy for igniting and/or re-igniting the welding arc is set according to the read-out parameter values of the welding parameters.

In a further possible embodiment of the method in accordance with the invention, the parameter set has an ignition current, I, an ignition voltage, U, and/or a pulse frequency and/or a wire conveyance speed, V_{D}, and/or a wire conveyance acceleration, a_{D}, of the consumable welding wire electrode during the ignition procedure.

In a further possible embodiment of the method in accordance with the invention, the welding process includes an ignition phase, a process start phase and a main process phase, wherein the ignition energy of the ignition procedures carried out respectively in the different phases is set according to the ignition method in accordance with the invention.

In a further possible embodiment of the method in accordance with the invention, the ignition energy for igniting and/or re-igniting the welding arc is automatically set in accordance with a stored characteristic curve in dependence upon the determined distance or determined time duration.

In a further possible embodiment of the method in accordance with the invention, the ignition energy for igniting and/or re-igniting the welding arc is determined or calculated in dependence upon the determined distance or determined time duration.

In a further possible embodiment of the method in accordance with the invention, the current amplitude for severing the consumable welding wire electrode after a detected short-circuit is set in dependence upon a diameter of the welding wire electrode and/or in dependence upon an electrical conductance and the specific heat capacity of the welding wire electrode.

The invention provides according to a further aspect an ignition device for igniting and/or re-igniting a welding arc between a wire end of a consumable welding wire electrode and a workpiece comprising

a determination unit which is suitable for determining a distance or time duration required by the free wire end of the consumable welding wire electrode until contact or short-circuit or ignition of the welding arc with a surface of the workpiece, and comprising

a setting unit which is suitable for setting an ignition energy for igniting and/or re-igniting the welding arc in dependence upon the distance or time duration.

Furthermore, according to a further aspect the invention provides an arc welding apparatus comprising an ignition device according to the second aspect of the invention.

### BRIEF DESCRIPTION OF FIGURES

Possible embodiments of the method in accordance with the invention and the ignition device in accordance with the invention will be explained in greater detail hereinafter with reference to the enclosed figures.

In the figures:

FIG. 1 shows a schematic flow diagram to illustrate an exemplified embodiment of the ignition method in accordance with the invention;

FIG. 2 shows a block diagram of one possible embodiment of the ignition device in accordance with the invention;

FIG. 3 shows a diagram to explain the mode of operation of the ignition method in accordance with the invention;

FIG. 4 shows a further diagram to explain the mode of operation of the ignition method in accordance with the invention.

### DETAILED DESCRIPTION OF EMBODIMENTS

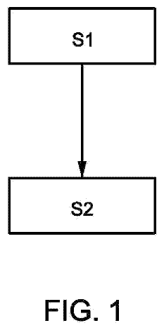

The ignition method in accordance with the invention for igniting and/or re-igniting a welding arc SLB between a wire end of a consumable welding wire electrode SDE and a workpiece W essentially has two main steps, as illustrated schematically in FIG. 1.

In a first step S1, a distance S or a time duration required by the wire end of the consumable welding wire electrode SDE until a contact or until a short-circuit with a surface of the workpiece W is determined.

In a further step S2, the welding arc SLB is ignited with an ignition energy E_{Z} which is set in dependence upon the determined distance S or the determined time duration. The ignition method for igniting and/or re-igniting the welding arc SLB as illustrated in FIG. 1 thus takes into account a current thermal state of the free end of the welding wire electrode SDE. This prevents insufficient or excessive ignition energy from being applied to the welding wire end in order to ignite the welding arc. This can prevent arc breaks. Furthermore, a welding start fault is avoided when igniting the welding arc SLB.

In one possible embodiment, the wire end of the consumable welding wire electrode SDE can be formed by severing the welding wire electrode at a melting point SS. In one possible embodiment, this severing of the welding wire electrode SDE is effected by applying a high electrical current I to the welding wire electrode. The welding wire electrode SDE is severed by the application of current as soon as a prolonged short-circuit or contact between the welding wire electrode SDE and the workpiece W has been detected.

The welding wire electrode SDE is conveyed towards the surface of a workpiece W at a wire conveyance speed V_{D} with a burning welding arc SLB. If the welding arc SLB for conveying the welding wire electrode SDE is extinguished, this can be detected in one possible embodiment.

In a possible embodiment, the distance S covered by a wire end of the consumable welding wire electrode formed at the melting point SS until contact or short-circuit with the surface of the workpiece W is determined in dependence upon the known wire conveyance speed V_{D} and a detected time difference Δt.

In a possible embodiment, the detected time difference includes a time period between the time of severing the consumable welding wire electrode SDE by the application of current and the time of contact or short-circuit of the wire end of the consumable welding wire electrode SDE with a surface of the workpiece W or the time of ignition of the welding arc.

Alternatively, the detected time difference can also include a time period between the time of the detected extinction of the welding arc SLB and the time of contact or short-circuit of the wire end of the consumable welding wire electrode SDE with the surface of the workpiece W or the time of ignition of the welding arc.

In a further possible alternative embodiment of the method in accordance with the invention, the distance S or time duration required by the wire end of the consumable welding wire electrode SDE until contact or short-circuit with the surface of the workpiece W is measured by sensors.

In a possible embodiment of the method in accordance with the invention, the ignition energy E_{Z} for igniting or re-igniting the welding arc SLB is automatically set higher when an increasing distance is determined or when an increasing time duration is determined.

In a possible embodiment, in the method illustrated in FIG. 1, associated parameter sets for welding parameters SP are read out from a parameter set memory for various distance values of the distance or detected time difference values and the ignition energy E_{Z} for igniting and/or re-igniting the welding arc SLB is set according to the read-out parameter values of the welding parameters SP.

A parameter set can include parameters, such as an ignition current I, an ignition voltage U, and/or a pulse frequency and/or a wire conveyance speed V_{D}, and/or a wire conveyance acceleration a_{D}, of the consumable welding wire electrode SDE during the ignition procedure. Additionally or alternatively, parameters such as an ignition current time and/or ignition voltage time can be included. Accordingly, the parameter sets or the parameters are selected according to the set or selected welding process (such as e.g. a short-circuit welding process or a pulse welding process).

In a possible embodiment, the ignition energy E_{Z} for igniting and/or re-igniting the welding arc SLB is automatically set according to a stored characteristic curve in dependence upon the determined distance and/or determined time duration. In one possible embodiment, the ignition energy E_{Z} for igniting and/or re-igniting the welding arc SLB is calculated by a computing unit in dependence upon the determined distance and/or determined time duration. This is effected accordingly in a manner adapted to the selected welding process and the event. The ignition energy can be varied by up to 90% compared to a normal ignition.

In a possible embodiment, the current amplitude for severing the consumable welding wire electrode SDE or in the event of a detected short-circuit is set in dependence upon a diameter of the welding wire electrode SDE. The larger the diameter of the welding wire electrode SDE, the larger the required current amplitude to sever the consumable welding wire electrode SDE. Furthermore, the current amplitude for severing the consumable welding wire electrode SDE can be set in dependence upon the electrical conductance and the specific heat capacity of the welding wire electrode SDE.

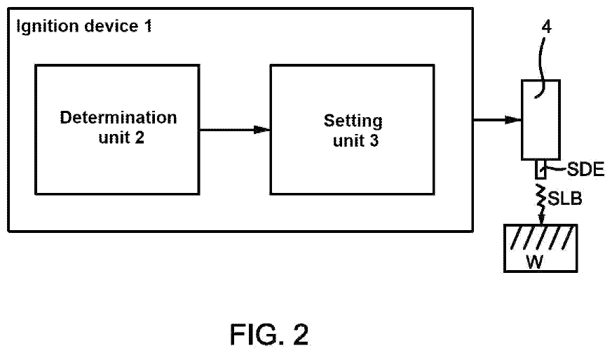

FIG. 2 shows a block diagram of one possible embodiment of the ignition device 1 in accordance with the invention in a further aspect of the invention. The ignition device 1 illustrated in FIG. 2 comprises a determination unit 2 and a setting unit 3. The ignition device 1 is used for igniting and/or re-igniting a welding arc SLB between a wire end of a consumable welding wire electrode SDE and a workpiece W, as illustrated schematically in FIG. 2. The welding wire electrode SDE is located on a welding torch 4 and can be unwound from a spool and conveyed towards the workpiece W. In one possible embodiment, the welding wire electrode SDE is conveyed at a specified known wire conveyance speed V_{D}. The determination unit 2 of the ignition device 1 is designed to determine a distance S or a time duration required by the wire end of the welding wire electrode SDE until contact or short-circuit with the surface of the workpiece W or until ignition. In one possible embodiment, the distance S covered by the wire end of the consumable welding wire electrode SDE until contact with the surface of the workpiece W is determined by the determination unit 2 in dependence upon the known wire conveyance speed V_{D} of the welding wire electrode and a detected time difference. Alternatively, the distance S covered by the wire end of the consumable welding wire electrode until contact or short-circuit with the surface of the workpiece W or ignition can be calculated by the determination unit 2 in dependence upon a known wire conveyance acceleration a_{D} and a detected time difference Δt. In one possible embodiment, the detected time difference Δt includes a time period between a time for severing the consumable welding wire electrode SDE by the application of current and a time of contact or short-circuit of the wire end of the consumable welding wire electrode SDE with the surface of the workpiece W or a time of ignition of the welding arc SLB. Furthermore, the detected time difference Δt can also include a time period between a time of an identified extinction of the welding arc SLB and a time of contact or short-circuit of the wire end of the consumable welding wire electrode SDE with the surface of the workpiece W or a time of ignition of the welding arc SLB.

In a further possible embodiment of the ignition device 1 in accordance with the invention, the distance S or a time duration required by the wire end of the consumable welding wire electrode SDE until contact or short-circuit with the surface of the workpiece W is measured with the aid of sensors and communicated to the determination unit 2. In this embodiment, the ignition device 1 has a timer or clock.

The setting unit 3 of the ignition device 1 is designed to automatically set an ignition energy E_{Z} for igniting and/or re-igniting the welding arc SLB in dependence upon the determined distance and/or determined time duration. The ignition energy E_{Z} for igniting and/or re-igniting the welding arc SLB is calculated in dependence upon the determined distance S or time duration. The ignition energy for igniting and/or re-igniting the welding arc SLB is automatically set higher by the setting unit 3 when an increasing distance is determined and/or an increasing time duration is determined. The longer the distance or the required time duration, the more the wire end of the consumable welding wire electrode SDE cools down and the more cold wire is fed in, and so a higher ignition energy E_{Z} is required to ignite or re-ignite the welding wire electrode SDE.

In one possible embodiment, associated parameter sets for welding parameters SP are stored in a parameter set memory of the ignition device 1 for various distance values of the distance S or detected time difference values. These are read out by the setting unit 3. The ignition energy E_{Z} for igniting and/or re-igniting the welding arc is set by the setting unit 3 according to the read-out parameter values of the welding parameters SP. In one possible embodiment, a read-out parameter set can include an ignition current I, an ignition voltage U, a wire conveyance speed V_{D} and/or wire conveyance acceleration a_{D} for the consumable welding wire electrode SDE during the ignition procedure. For a pulsed arc, the parameter set can additionally include a pulse frequency. In a further possible embodiment, the ignition energy E_{Z} for igniting and/or re-igniting the welding arc can be automatically set by the setting unit 3 according to a stored characteristic curve in dependence upon the determined distance S and/or determined time duration. The ignition device 1 illustrated in FIG. 2 is integrated in an arc welding apparatus, and so a welding process can be performed. Further required components of the arc welding apparatus, which are generally known, are not discussed here.

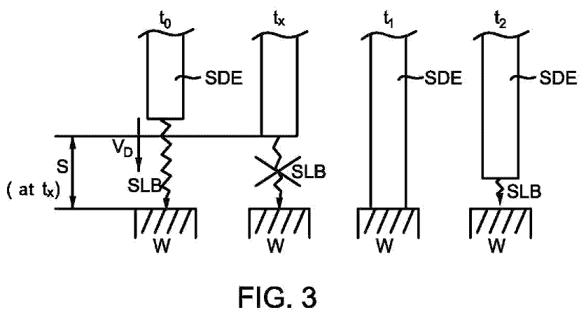

FIG. 3 schematically shows the mode of operation of the ignition device 1 in accordance with the invention. At time to, a welding wire electrode SDE is conveyed at a wire conveyance speed V_{D} in the direction towards a surface of a workpiece W. A welding arc SLB can be present between the free wire end of the welding wire electrode SDE and the surface of the workpiece W. However, at time tx the SLB is extinguished by reason of malfunction or the like. The extinction of the SLB is illustrated symbolically by an “x”. With this event the path measurement is activated. At time t₁, the wire end of the welding wire electrode SDE contacts the surface of the workpiece W. The contact ignites the welding arc SLB. The contact at time t₁ can be detected. In the process, a slight material transition can result. Some material melts off at the tip of the welding wire electrode SDE. At time t₂, the welding wire electrode SDE is moved to the surface of the workpiece W at reduced feed speed V_{D}, wherein a welding arc SLB is ignited with that ignition energy E_{Z} which is set at least in dependence upon the measured distance, as illustrated schematically in FIG. 3. In an alternative embodiment, the welding wire electrode SDE can also be moved away from the surface of the workpiece W at time t₂. The set ignition energy E_{Z} takes into account the thermal state of the wire end of the welding wire electrode SDE at contact time t₁. The greater the distance S covered or the time Δt required for this, the more the wire end of the welding wire electrode SDE has cooled down and/or the more cool wire has been fed in and the higher the ignition energy E_{Z} for igniting the welding arc is set in the method in accordance with the invention and the ignition device 1 in accordance with the invention.

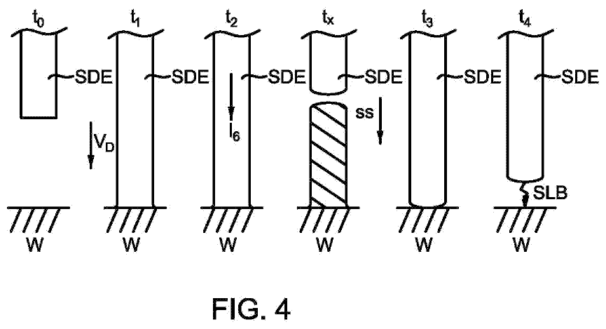

FIG. 4 shows a situation, in which the wire end of the welding wire electrode SDE pecks or is welded in contact with the surface of the workpiece W during a starting procedure of the welding procedure. At time to, the welding wire electrode SDE moves at the known wire conveyance speed V_{D} in the direction towards the surface of the workpiece W, wherein a welding arc SLB can burn; before the first ignition, no welding arc SLB burns at time to. At time t₁, the welding wire end of the welding wire electrode SDE contacts the surface of the workpiece W, wherein an end piece of the welding wire electrode SDE remains adhered to the surface of the workpiece W undesirably. In order to detach this, an electric current I_{b} with a high current amplitude is applied to the adhering welding wire electrode SDE at time t₂ to cause the welding wire electrode SDE to be severed. Furthermore, at time t₂ the wire feed speed V_{D} can be reduced. As shown in FIG. 4, this results in a new wire end of the consumable welding wire electrode SDE at a melting point SS at time tₓ. By reason of the high application current I_{b}, the lower separated part of the welding wire electrode SDE, shown hatched in FIG. 4 at time tₓ, becomes liquid and can spray away. This is identified as an event and the path measurement is started/activated. Equally, the newly formed welding wire end of the welding wire electrode SDE is now conveyed in the direction towards the surface of the workpiece W at a wire conveyance speed V_{D}. The wire end—newly formed at the melting point SS—of the welding wire electrode SDE contacts the surface of the workpiece W at a time t₃, as illustrated in FIG. 4. The contact causes a welding arc SLB to ignite at time t₄. In one possible embodiment, the new welding wire end formed at the melting point SS can then be moved back from the surface of the workpiece W. In the scenario illustrated in FIG. 4, the newly formed wire end of the welding wire electrode SDE is strongly heated at the melting point SS by reason of the high application current I_{b} and is thus significantly warmer than e.g. a wire end of a welding wire electrode at the beginning of a welding procedure. This additional information is preferably taken into account by the setting unit 3 of the ignition device 1 for setting the ignition energy E_{Z} at time t₃.

If, as a result of undesired adhesion (event) during a welding process of the welding wire electrode SDE to the surface of the workpiece (time t₁), a high current I_{b} (t₂) is applied to the welding wire electrode SDE to form a melting point SS, the ignition energy E_{Z} for the SLB required at time t₃ can be set correspondingly lower at t₄. In this embodiment, the ignition energy E_{Z} is thus preferably set not only in dependence upon the determined distance S or the time duration required for this, but also in dependence upon the amplitude of the severing current I_{b} flowing at time t₂. The higher the current amplitude of the current I_{b} provided for melting the welding wire electrode SDE, the lower the ignition energy E_{Z} for re-igniting the welding arc SLB at time t₃ can be set by the setting unit 3. In one possible embodiment, the heat or energy introduced into the welding wire electrode SDE is determined, in particular calculated on the basis of the welding parameters and the known material properties of the welding wire electrode SDE. The higher the determined heat input, the lower the ignition energy E_{Z} is set.

In a further scenario, a breaking (event) of a welding arc SLB can be detected during the welding procedure. The time between the breaking of the welding arc SLB and the contact of the welding wire electrode SDE with the surface of the workpiece W can be measured or recorded. The longer the recorded time duration, the more the end of the welding wire electrode SDE has cooled down and the higher the ignition energy E_{Z} is set by the setting unit 3 of the ignition device 1. Undesired adhesion of the welding wire electrode SDE to the workpiece W occurs in conventional welding methods primarily during the first ignition procedure. In the case of arc breaks, in rare cases the situation can also arise that after an ignition fault the welding wire end of the welding wire electrode SDE is welded or adheres to the workpiece W, as illustrated schematically in FIG. 4. In order to break the short-circuit resulting therefrom, the welding wire electrode SDE is preferably energized with a current I_{b} of high amperage (time t₂) in the method in accordance with the invention. In this short-circuit treatment procedure, the welding wire electrode SDE can melt through at different positions or melting points SS. After melting through of the welding wire electrode SDE, the welding wire electrode SDE is conveyed forwards in the direction towards the surface of the workpiece W. Subsequently, a new contact ignition is effected to form a welding arc SLB with the aid of the set ignition energy E_{Z}.

In the ignition device 1 in accordance with the invention, from the time of melting through of the welding wire electrode SDE or from the time of an identified arc break until the time of re-ignition, the distance S covered by the welding wire electrode SDE and/or the time required for this is recorded and the position of the melting point or the arc break is derived therefrom. It can also be said that the path or time is recorded depending on an event. The determined distance S or the recorded time difference is representative of the melting point at which the welding wire electrode has been melted through at time tₓ. From this, the required optimum ignition energy E_{Z} can be determined or calculated. If e.g. the welding wire electrode SDE is melted through directly at a base point (base point=welded point with the workpiece), the ignition energy E_{Z} can be set relatively low, since a high short-circuit current I_{b} was used for breaking the short-circuit and thus the free wire end is already relatively strongly preheated. However, if the welding wire electrode SDE has melted through in the direction of the contact tube of the welding torch 4, the welding wire electrode SDE has to cover a relatively long path or large distance S until it contacts the surface of the workpiece W once again, and so an increased ignition power E_{Z} is set by the setting unit 3 for renewed ignition. The increased ignition power E_{Z} is required because the wire end of the welding wire electrode SDE, which is conveyed forwards, has already cooled down during the forwards movement and in addition cold wire is fed in.

By reason of an event at time tₓ, the welding arc SLB is thus ignited with an ignition energy corresponding to the method in accordance with the invention. After ignition or re-ignition, a start phase can preferably be performed, in which the parameters can likewise be adapted in dependence upon the distance covered. For example, the wire feed is increased more rapidly (with a steeper ramp) in the start phase if the welding arc SLB was ignited with a lower ignition energy—i.e. the welding wire was heated more strongly.

After the start phase, the set welding process is performed. The ignition device 1 in accordance with the invention provides a wire-thermally controlled arc ignition and in particular takes into account a current thermal state of the wire end of a welding wire electrode SDE. This allows the ignition energy E_{Z} for igniting or re-igniting the welding arc SLB to be set in an optimum manner. As a result, arc breaks or weld start faults are substantially avoided. The productivity of the arc welding apparatus is increased accordingly.

### LIST OF REFERENCE SIGNS

1 ignition device
2 determination unit
3 setting unit
4 welding torch

1. A method for igniting and/or re-igniting a welding arc between a wire end of a consumable welding wire electrode and a workpiece after an event comprising the steps of:
determining a distance or time duration required by the free wire end of the consumable welding wire electrode until contact or short-circuit with a surface of the workpiece or until ignition of the welding arc; and
igniting the welding arc with an ignition energy which is set in dependence upon the determined distance or time duration.

2. The method as claimed in claim 1, wherein the distance covered by the free wire end of the consumable welding wire electrode formed at a melting point until contact or short-circuit with the surface of the workpiece is determined in dependence upon the wire conveyance speed and a detected time difference.

3. The method as claimed in claim 1, wherein the distance covered by the free wire end of the consumable welding wire electrode formed at a melting point until contact or short-circuit with the surface of the workpiece is determined in dependence upon a wire conveyance acceleration and a detected time difference.

4. The method as claimed in claim 2, wherein the detected time difference includes a time period between the time of severance of the consumable welding wire electrode or extinction of the welding arc and the time of contact or short-circuit of the free wire end of the consumable welding wire electrode with the surface of the workpiece.

5. The method as claimed in claim 1, wherein the distance or time duration required by the wire end of the consumable welding wire electrode until contact or short-circuit with the surface of the workpiece is measured by sensors.

6. The method as claimed in claim 1, wherein the ignition energy for igniting and/or re-igniting the welding arc is automatically set higher when an increasing distance is determined or when an increasing time duration is determined.

7. The method as claimed in claim 1, wherein associated parameter sets for welding parameters are read out from a parameter set memory for various distance values of the distance or detected time difference values, and the ignition energy for igniting and/or re-igniting the welding arc is set according to the read-out parameter values of the welding parameters.

8. The method as claimed in claim 7, wherein the parameter set includes an ignition current an ignition voltage and/or a pulse frequency and/or a wire conveyance speed and/or a wire conveyance acceleration of the consumable welding wire electrode during the ignition procedure.

9. The method as claimed in claim 1, wherein the ignition energy for igniting and/or re-igniting the welding arc is automatically set in accordance with a stored characteristic curve in dependence upon the determined distance or determined time duration.

10. The method as claimed in claim 1, wherein the ignition energy for igniting and/or re-igniting the welding arc is calculated in dependence upon the determined distance or time duration.

11. The method as claimed in claim 2, wherein a current amplitude for severing the consumable welding wire electrode after a detected short-circuit is set in dependence upon a diameter of the welding wire electrode of the specific conductance and/or the specific heat capacity of the welding wire electrode.

12. An ignition device for igniting and/or re-igniting a welding arc between a wire end of a consumable welding wire electrode and a workpiece, comprising:
a determination unit which is suitable for determining a distance or time duration required by the free wire end of the consumable welding wire electrode until contact or short-circuit with a surface of the workpiece or until ignition of the welding arc; and comprising
a setting unit which is suitable for setting an ignition energy for igniting and/or re-igniting the welding arc in dependence upon the distance or time duration.

13. An arc welding apparatus comprising an ignition device for igniting and/or re-igniting a welding arc between a wire end of a consumable welding wire electrode and a workpiece and comprising a welding torch,
said ignition device comprising:
a determination unit which is suitable for determining a distance or time duration required by the free wire end of the consumable welding wire electrode until contact of short-circuit with a surface of the workpiece or until ignition of the welding arc; and comprising
a settling unit which is suitable for setting an ignition energy for igniting and/or re-igniting the welding arc in dependence upon the distance or time duration.
